(19) United States
(12) Patent Application Publication
(10) Pub. No.: US 2008/0314259 A1
(43) Pub. Date: Dec. 25, 2008

(54) BAKING TRAY

(76) Inventor: Gregory Alan Broom, Richardson, TX (US)

Correspondence Address: Andre M. Szuwalski;Gardere Wynne Sewell LLP, 3000 Thanksgiving Tower, 1601 Elm Street, Dallas, TX, 75201, US

(21) Appl. No.: 11/766,354

(22) Filed: Jun. 21, 2007

Related U.S. Application Data
(63) Continuation-in-part of application No. 29/285,143, filed on Mar. 22, 2007, now Pat. No. D574180.
Application No. 29/285,143 is a continuation-in-part of application No. 29/285,150, filed on Mar. 22, 2007, now Pat. No. D574181.
Application No. 29/285,150 is a continuation-in-part of application No. 29/285,153, filed on Mar. 22, 2007, now Pat. No. D574183.
(60) Provisional application No. 60/815,459, filed on Jun. 21, 2006.

(51) Int. Cl. A23P 1/10; B28B 7/24

(52) U.S. Cl. 99/426; 249/119

(57) ABSTRACT

A baking tray includes one or more cups. The cups are arranged in an array format. Each has an encircling side wall defining an open volume for receiving food products. A disk washer-shaped bottom wall having an outer peripheral edge is joined to a bottom edge of the encircling side-wall. The disk washer-shaped bottom wall has a circular opening therein. A dome-shaped structure is joined to the circular opening and extends upwardly into the open volume within the encircling side wall.

### CROSS-REFERENCE TO RELATED APPLICATIONS

The present application claims priority to U.S. Provisional Application for Patent No. 60/815,459 filed Jun. 21, 2006, and is a continuation-in-part of U.S. Design applications for patent Nos. 29/285143, 29/285,150 and 29/285,153, the disclosures of all of which are hereby incorporated by reference.

### BACKGROUND OF THE INVENTION

### Technical Field

The present invention relates to a baking tray for baking confectionery products The baking tray may have any shaped or size desired which would include a bowl or cup configuration with a central dome shaped interior surface. Baking trays of a round) rectangular, loaf, pie shell, pie wedge, etc. may be used.

### SUMMARY OF THE INVENTION

A baking tray comprises: a cup having an encircling side wall defining an open volume for receiving food products, a disk washer-shaped bottom wall having an outer peripheral edge joined to a bottom edge of the encircling side-wall, the disc washer-shaped bottom wall having a circular opening therein, and a dome-shaped structure joined to the circular opening and extending upwardly into the open volume within the encircling side wall.

A baking tray comprises: a bowl having a peripheral side wall, a bottom wall having an outer peripheral edge joined to a bottom edge of the peripheral side-wall, and domed structure extending upwardly from the bottom wall, the peripheral side wall describing a particular shape and the domed structure having a corresponding shape.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a perspective top view of a single-cup baking tray according to an embodiment;

FIG. 2 is a side view of the tray shown in FIG. 1;

FIG. 3 is a top view of the tray shown in FIG. 1;

FIG. 4 is a cross-sectional view of the tray shown in FIG. 1;

FIG. 5 is a bottom view of the tray shown in FIG. 1;

FIG. 6 is a perspective top view of a two-cup baking tray according to an embodiment;

FIG. 7 is a first side view of the tray shown in FIG. 6;

FIG. 8 is a second side view of the tray shown in FIG. 6;

FIG. 9 is a top view of the tray shown in FIG. 6;

FIG. 10 is a cross-sectional view of the tray shown in FIG. 6;

FIG. 11 is a bottom view of the tray shown in FIG. 6;

FIG. 12 is a perspective top view of a six-cup baking tray according to an embodiment;

FIG. 13 is a first side view of the tray shown in FIG. 12;

FIG. 14 is a second side view of the tray shown in FIG. 12;

FIG. 15 is a top view of the tray shown in FIG. 12;

FIG. 16 is a cross-sectional view of the tray shown in FIG. 12;

FIG. 17 is a bottom view of the tray shown in FIG. 12;

FIG. 18 is a perspective top view of a four-cup baking tray according to an embodiment (whose first and second side views are shown by FIG. 8).

### DETAILED DESCRIPTION OF THE DRAWINGS

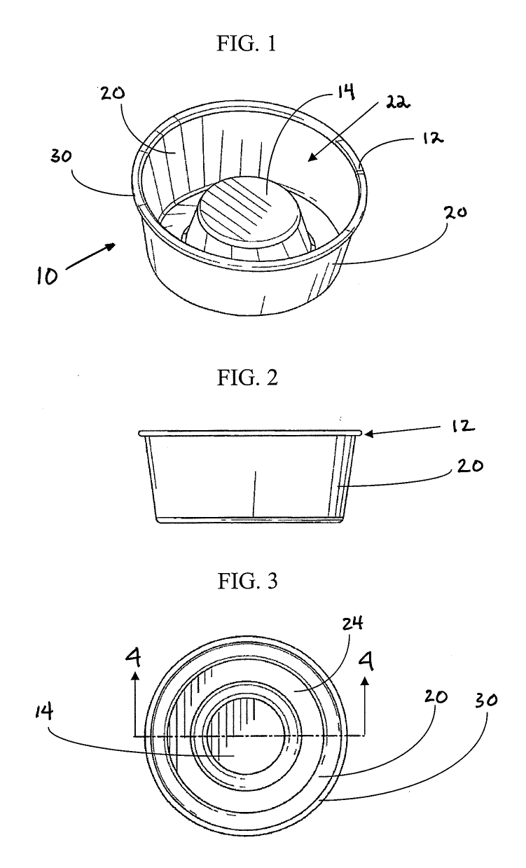

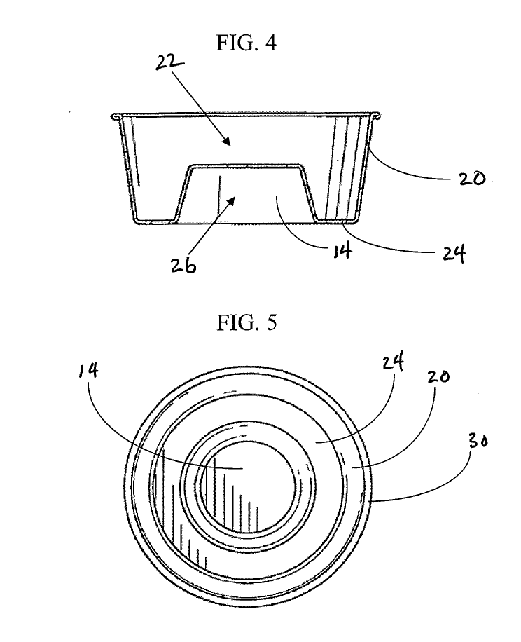

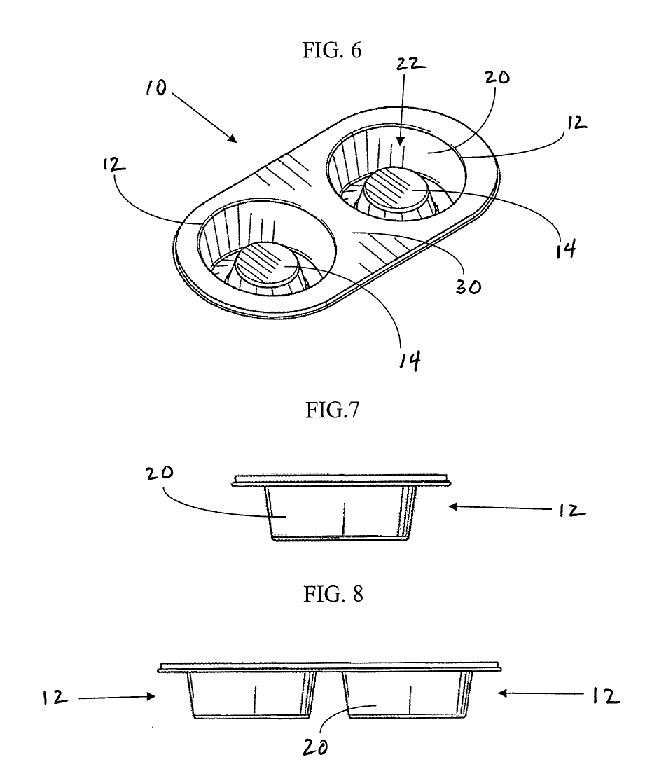

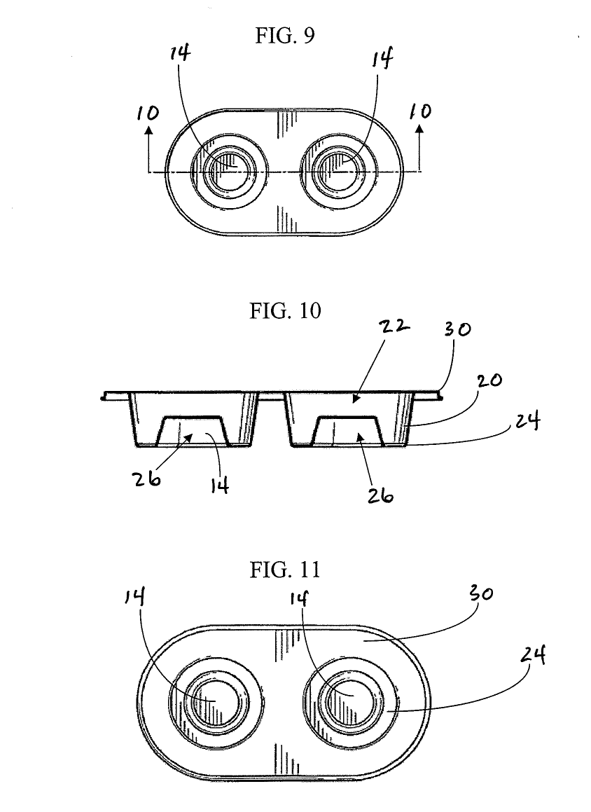

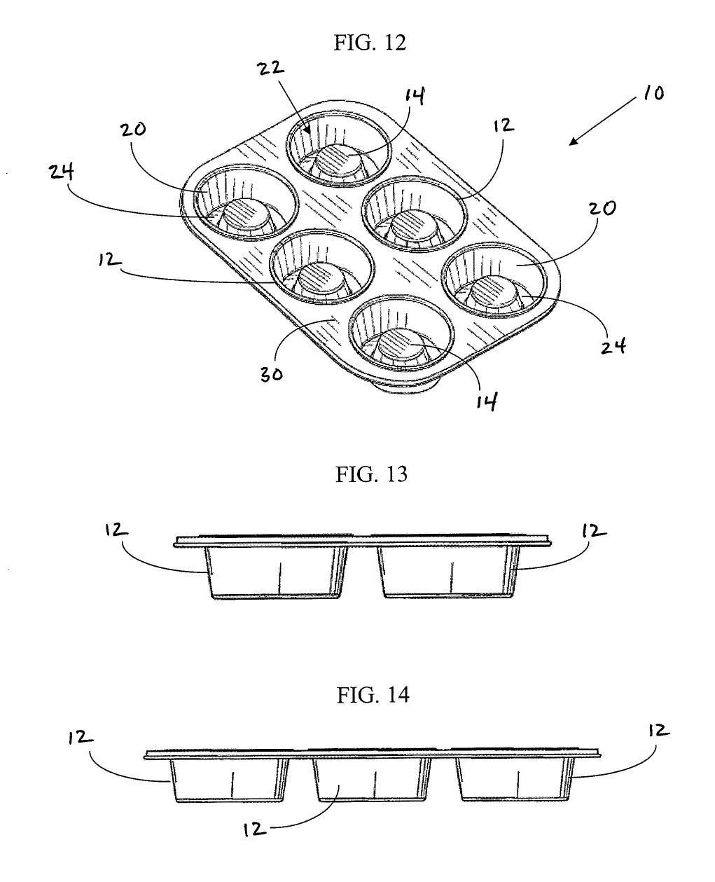

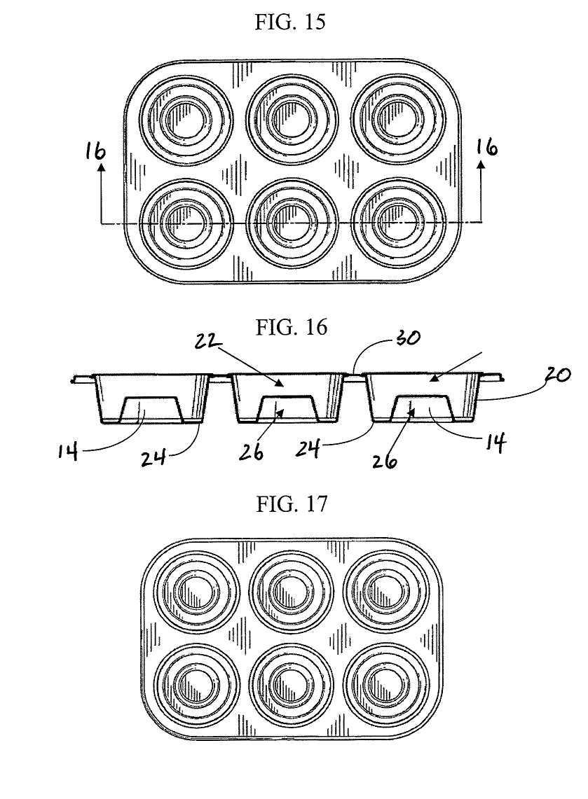

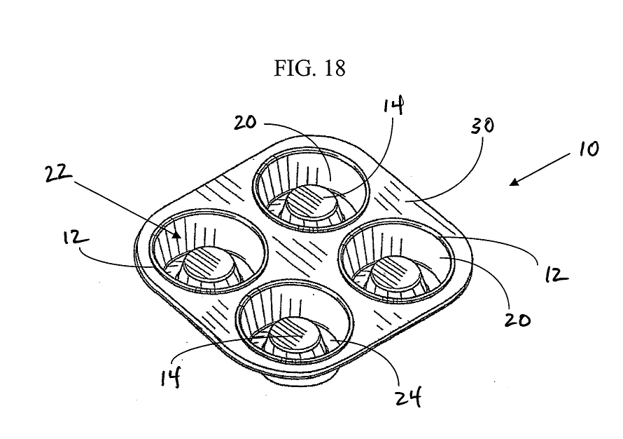

The baking tray 10 as disclosed in FIGS. 1-18 comprises one or more baking wells (or cups) 12. More specifically, the baking tray 10 can have any of a myriad of configurations (including, for example, in array format such as 1×1; 2×1; 2×2; 3×2; 4×2 and 4×3). The baking wells 12 of the baking tray 10 can be arranged in any selected number of rows and columns as desired for a given application.

The baking tray 10 is adapted to bake food products which may be, for example, muffins, brownies, angel food cake, bread including corn bread, jello, cake, whipped cream bowls, pan cakes, and the like. The baking wells 12 include, on the interior and extending upward from a base, a dome shape (e.g., a convex surface) 14. The dome shape 14 is configured and adapted to provide a bowl like shape opening on the inside of the food products which results from being baked/cooked in and produced from the baking tray 10. The food products obtained from using the baking tray are adapted to be used as an edible bowl wherein a bowl-like opening in the edible bowl may be filled with selected food stuff such as beans, jello, ice cream, stew, chili, apple fillings, or any food product which may otherwise be eaten from a non-edible bowl, or any other kind of filling that may be, for example, in crepes or on pancakes. It is the dome shape 14 in the tray 10 which produces in the baked product the bowl shape opening which can receive food stuff as described above.

The baking tray 10 has a resilient and flexible shape and can be made of various materials which are heat resistant and flame resistant. In one embodiment, the baking tray 10 can be made of a material that is heat resistant, hygienic, and easy to clean, e.g., silicone. The tray can also be made of metallic products such as aluminum or carbon coated steel. Although the baking tray 10 is disclosed as being preferably formed of silicone, it will be appreciated that the baking tray 10 can be formed from a variety of different materials (such as elastomers, rubbers and any other material that is flexible/inflexible, heat resistant and/or flame resistant).

The wells 12 are defined by an encircling side wall 20. This side wall defines an open volume 22 for receiving the baking food products. Although the side wall 20 is illustrated as having a slope, it will be understood that such is not necessarily required. The limitation with respect to the side wall slope is that it cannot form an undercut which would make removal of the baked food product from the tray difficult. A disk washer-shaped bottom wall 24 has an outer peripheral edge which is joined to a bottom edge of the encircling side-wall 20. The disk washer-shaped bottom wall further includes a circular opening 26 therein. The dome-shape 14 structure is joined at its bottom circular peripheral edge to the edge of the circular opening 26. This dome shape 14 extends upwardly from the bottom wall 24 into the open volume 22 defined within the encircling side wall 20. A shoulder surface 30 is provided attached to a top edge of the encircling side-wall.

Although the illustrated embodiment shows cups which have a round shape (in horizontal cross section), it will be recognized by those skilled in the art that alternative shapes for the cups are possible. For example, the cup could have a square shape (with a correspondingly square shaped dome), or a rectangular shape (with a correspondingly rectangular shaped dome) or have a pie wedge shape (with a correspondingly pie wedge shaped dome). Of course, the cup could have a full pie (i.e., circular) shape but with a shorter height. In this regard, one skilled in the art would recognize that the cup can have any selected height (depth). As an example, circular shapes with three-inch and five-inch diameters have been found to be commercially successful.

Ornamental features of the cup include: the configuration of the surface 30; slope of the side wall 20; rounding of edges; edges for the shapes of the dome 14 (which can, for example, include curved edges which might define a rounded surface similar to a hemisphere or sharper edges which might define a truncated cone as is illustrated in the figures).

The side wall 20 slope, the two-dimensional shape (in horizontal cross section) defined by the peripheral side wall and the dome 14 shape define the shape of the resulting baked food product, as well as the size of the bowl formed in the resulting baked food product which can receive food stuff.

Although preferred embodiments of the apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed:

1. A baking tray, comprising:
a cup having an encircling side wall defining an open volume for receiving food product, a disc washer-shaped bottom wall having an outer peripheral edge joined to a bottom edge of the encircling side-wall, the disc washer-shaped bottom wall having a circular opening therein, and a dome-shaped structure joined to the circular opening and extending upwardly into the open volume within the encircling side wall.

2. The tray of claim 1 wherein the tray includes a plurality of cups.

3. The tray of claim 2 wherein plurality of cups are arranged in an array format.

4. A baking tray comprising:
a bowl having a peripheral side wall, a bottom wall having an outer peripheral edge joined to a bottom edge of the peripheral side-wall, and domed structure extending upwardly from the bottom wall, the peripheral side wall describing a particular shape and the domed structure having a corresponding shape.

5. The baking tray of claim 4 wherein the particular shape and the corresponding shape are circular.

6. The baking tray of claim 4 wherein the particular shape and the corresponding shape are rectangular.

7. The baking tray of claim 4 wherein the particular shape and corresponding shape are pie wedge shapes.

8. The baking tray of claim 4 wherein the particular shape and the corresponding shape are square.

9. The tray of claim 4 wherein the tray includes a plurality of bowls.

10. The tray of claim 9 wherein plurality of bowls are arranged in an array format.
